(19) United States
(12) Patent Application Publication
(10) Pub. No.: US 2026/0070051 A1
(43) Pub. Date: Mar. 12, 2026

(54) PIPETTING ELEMENT, PIPETTING DEVICE, AND PIPETTING KIT

(71) Applicant: Leica Microsystems CMS GmbH, Wetzlar (DE)

(72) Inventor: Stefan CHRIST, Wetzlar (DE)

(21) Appl. No.: 19/103,829

(22) PCT Filed: Aug. 19, 2022
(86) PCT No.: PCT/EP2022/073225

§ 371 Date: Feb. 14, 2025

(51) Int. Cl. B01L 3/02; B01L 3/00

(52) U.S. Cl. CPC B01L 3/0265; B01L 3/5085; B01L 2200/025; B01L 2200/16; B01L 2300/0672; B01L 2300/18; B01L 2400/0406; B01L 2400/0457; B01L 2400/0487; B01L 2400/049; B01L 2400/0683

(57) ABSTRACT

A pipetting element for use with a pipetting device includes at least two wells arranged in or forming a frame. The frame is configured to be received by the pipetting device. Each respective well of the at least two wells is configured to receive a pipetting liquid and has a release portion arranged at one side of the respective well. The release portion is configured to be triggered by the pipetting device in order to release the pipetting liquid.

### CROSS REFERENCE TO RELATED APPLICATIONS

This application is a U.S. National Phase application under 35 U.S. C. § 371 of International Application No. PCT/EP2022/073225, filed on Aug. 19, 2022. The International Application was published in English on Feb. 22, 2024 as WO 2024/037726 A1 under PCT Article 21(2).

### FIELD

Embodiments of the present invention relate to a pipetting element for use with a pipetting device. Embodiments of the invention also relate to a pipetting device and to a pipetting kit.

### BACKGROUND

In particular in the field of spatial omics, samples are subjected to multiple cycles of manipulation and treatment with various reagents, in order to study various biological processes. The reagents are for example probes, antibodies or chemicals. In particular, when the reagents comprise fluorophores, the reagents are also called markers. A single experiment may comprise multiple cycles of staining and bleaching. Typically, a cycle comprises the following steps: In a first part the sample is stained with one or more reagents by injecting the reagent into the sample, annealing the reagent, and washing the sample with a washing buffer. Then the sample is usually imaged using a microscope. In a second part the sample is bleached by bleaching by removing markers from the first staining and/or unmasking epitopes, and washing the sample with a washing buffer a second time to remove the used reagents.

The staining and washing steps required are performed either manually on a work bench or with an automated system such as an immunohistochemistry (IHC) stainer. Integrated solutions exist that combine a stainer with a microscope in order to reduce the time needed to handle the samples.

In multiplexed applications, multiple cycles of staining and bleaching are performed with the same sample using different reagents in each cycle. Especially in these multiplexed applications, carryover between injections is a big issue, since antibodies and other proteins have a tendency to stick to surfaces including the inside of injection needles and tubes. This excludes standard injection solutions which typically use only one injection tube from being used in multiplexed applications.

Further, for example in immunofluorescence (IF) staining, the cost of staining solutions is very high, as antibodies and stains are very expensive. The standard solutions are unsuitable for these applications involving expensive reagents because they use too much staining solution per injection. Most volume in standard injecting solutions is dead volume, for example in tubes and pumps. In addition, antibodies and IF staining solutions are sensitive to light and temperature, which also excludes most standard injection solutions.

### SUMMARY

Embodiments of the present invention provide a pipetting element for use with a pipetting device. The pipetting element includes at least two wells arranged in or forming a frame. The frame is configured to be received by the pipetting device. Each respective well of the at least two wells is configured to receive a pipetting liquid and has a release portion arranged at one side of the respective well. The release portion is configured to be triggered by the pipetting device in order to release the pipetting liquid.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic side view of a pipetting element according to an embodiment;

FIG. 2 is a schematic top view of the pipetting element according to FIG. 1;

FIG. 3 is a schematic view of a pipetting device according to an embodiment;

FIG. 4 is a schematic view of the pipetting device according to FIG. 3;

FIG. 5 is a schematic detail view of the pipetting device according to FIGS. 3 and 4;

FIG. 6 is a schematic top view of the pipetting device according to FIGS. 3 to 5; and

FIG. 7 is a flow chart of the method for preparing the sample that can be performed with the pipetting device according to FIGS. 3 to 6.

### DETAILED DESCRIPTION

Embodiments of the present invention provide a pipetting element and a pipetting device that that allow for an efficient pipetting of samples, in particular in multiplexed applications.

The pipetting element for use with a pipetting device comprises at least two wells arranged in or forming a frame. The frame is configured to be received by the pipetting device. Each well is configured to receive a pipetting liquid and has a release portion arranged at one side of the well. The release portion is configured to be triggered by the pipetting device in order to release the pipetting liquid. The wells may be configured to be detachable from the frame. The release portion is preferably arranged at the bottom of its respective well.

Within the context of this document pipetting can mean dropping or dispensing a fluid onto a sample, injecting a sample with a fluid or removing a fluid from a sample or a sample carrier. The pitting element typically has 6, 12, 24, or 96 wells. However, the number of wells can be in the range between 2 and 384.

The pipetting liquids, i.e. reagents to be injecting into the sample, are stored in individual distinct wells. Thus, cross-contamination between different pipetting liquids and carryover between staining cycles are not an issue with the proposed pipetting element. The pipetting liquid is not guided through pumps and tubing, and thus no pipetting liquid is left in dead volume such as pumps or fluid lines. Instead, the content of a well is directly applied to a sample volume via the release portion as further described below. The individual wells can be emptied partially or completely via the release portion. Thereby, the pipetting element facilitates the use of very small amounts of pipetting liquid, for example as low as a few microliters. This significantly reduces the cost of an experiment where expensive pipetting liquids are used, for example antibodies and stains used in immunofluorescence (IF). Further, the pipetting element does not comprise complex mechanical components and can be manufactured at a low cost. This allows the pipetting element to be used as a consumable, thereby further reducing the risk of cross-contamination and carryover as well as reducing the cost of experiments involving the pipetting element. Thus, overall, the proposed pipetting element allows for an efficient pipetting of samples, in particular in multiplexed applications.

In a preferred embodiment, the release portion is configured to be triggered mechanically by a trigger portion of the pipetting device or a sample carrier in order to release the pipetting liquid. For example, the release portion may comprise a small latch that is opening when the release portion engages with the trigger portion, thereby releasing the pipetting fluid. Mechanical solutions are simple and reusable, thereby making the pipetting device more cost effective and versatile.

In another preferred embodiment, the release portions each comprise a membrane configured to be punctured by a puncturing element of the pipetting device or a sample carrier in order to release the pipetting liquid. In this embodiment, the membrane holding back the pipetting liquid is punctured by the puncturing element when the release portion engages with the puncturing element, thereby releasing the pipetting liquid. This mechanical embodiment of the release portion is particularly simple and cost-effective.

In another preferred embodiment, the release portions each comprise a or the membrane having a slit configured to release the pipetting liquid when an overpressure is applied to the well. When no overpressure is applied to the well, the slit is closed and the membrane holds back the pipetting liquid. When overpressure is applied to the well, the slit in the membrane opens and the pipetting liquid is released. Thus, this embodiment requires no elements of the pipetting device to be arranged near the release portions, making the pipetting device simpler and less cluttered. Further, a negative pressure may be applied to the well allowing a liquid to be sucked into the well via the slit in the membrane. This allows the pipetting element to be used for dispensing as well as removing fluids, thereby making the pipetting element more versatile.

In another preferred embodiment, the release portion is configured to be triggered by an electrical signal received from the pipetting device in order to release the pipetting liquid. As an alternative or in addition to a mechanical trigger, the release portions may also be triggered electrically. This allows a very precise control over the release, because the release portion does not need to mechanically engage with any element of the pipetting device or the sample carrier in order to release the pipetting liquid. It further allows to trigger the release portions concurrently or consecutively in any order, making the pipetting element very flexible. In this embodiment, the release portion may for example be formed by an electrically controllable valve such as a diaphragm valve or an iris valve.

In another preferred embodiment, an inner surface of at least one of the wells comprises a functional coating, in particular at least one of a bio-coating, a nano-coating, a hydrophobic and a hydrophilic coating. A functional coating may for example prevent the pipetting liquid from sticking to the inner surface of the wells. This allows more of the pipetting liquid to be actually dispensed which is especially important if the pipetting liquid is very expensive, for example antibodies or IF stains. A functional bio coating may comprise proteins, for example albumins such as bovine serum albumin, creating an interface between the pipetting liquid and the wells, thereby limiting the exposure of the pipetting liquid to the material the wells are made out of. Such a coating can protect very sensitive and often very expensive pipetting liquids from spoiling.

In another preferred embodiment, the pipetting elements comprises a lid configured to be received on the frame and to cover some or all wells when the lid is received on the frame. The lid may for example be a plastic lid configured to cover one or more wells. The lid may also be a foil such as an aloe, plastic or aluminum foil. The lid prevents the pipetting liquid from drying out or coming into contact with pollutants in the air. Thereby, the lid prevents spoilage of the pipetting liquid.

In another preferred embodiment, at least one of the wells is configured to be lighttight. In particular antibodies and IF staining solutions are sensitive to light. By protecting these expensive pipetting liquids from light, the pipetting element prevents spoilage of the pipetting liquid, making the pipetting more efficient by reducing waste and cost.

In another preferred embodiment, the frame is rectangular and the wells are arranged inside the frame in a grid-like manner. In particular, the frame may have the dimensions of a microwell plate or a standard microwell plate stage insert. This greatly increases versatility and interoperability of the pipetting element. For example, this allows the pipetting element to be used in a variety of laboratory automation systems designed to use microwell plates.

In another preferred embodiment, each well has a capacity of at least 10 μl and at most 200 μl, preferably at least 25 μl and at most 100 μl. Most applications require amounts of pipetting liquid within the aforementioned ranges. Thus, the pipetting element according to this embodiment is compatible with a large number of applications, thereby making it very versatile.

In another preferred embodiment, each well comprises an individual identifier. The individual identifier may comprise any one of the following, a color, an alphanumeric string, a two-dimensional shape, and a three dimensional shape. The individual identifiers allow a user to quickly identify the wells and their content, making the pipetting element easier to use. Preferably, the wells are configured to be detachable from the frame, and the frame comprises matching identifiers indicating a predetermined position for each well within the frame. In this embodiment, the individual identifiers also allow the user to quickly arrange or exchange the wells at predetermined positions in the frame facilitating easy handling.

Embodiments of the invention also relate to a pipetting device for pipetting a sample comprising at least one pipetting element as described above, and a pipetting unit. The pipetting unit comprises a sample position configured to receive the sample, a storage compartment configured to receive the pipetting element, a positioning unit configured to move the pipetting element between at least the storage compartment and the sample position, and a trigger unit configured to trigger the pipetting element to release the pipetting liquid.

The pipetting device has the same advantages as the pipetting element described above and can be supplemented using the features of the dependent claims directed at the pipetting element.

In a preferred embodiment, the storage compartment comprises a temperature control unit configured to control the temperature of the storage compartment. Alternatively, or additionally, the storage compartment may comprise a humidity control unit configured to control the humidity of the storage compartment. Many pipetting liquids are not only sensitive to light but also have very specific temperature and/or humidity requirements, and may decompose when stored at the wrong temperature and humidity, respectively. By storing the pipetting liquids in a controlled environment, waste is further decreased and the efficiency of the staining and bleaching cycles is further increased. Further, storing the reagents in a controlled environment increases the stability of the reagents, allowing long term experiments to be performed with the pipetting device.

In another preferred embodiment, the positioning unit comprises a movable shelf configured to receive the pipetting element. The positioning unit is configured to move the movable shelf between the storage compartment and the sample position. Preferably, the positioning unit is configured to fully retract the movable shelf into the storage compartment. The pipetting element can easily be inserted into and removed from the shelf, making the pipetting device very fast and easy to use.

Preferably, the trigger unit is configured to generate at least one of a capillary force, a gravity flow, an overpressure and a negative pressure in each of the wells of the pipetting element individually. By generating a capillary force, a gravity flow or an overpressure in one of the wells, the pipetting liquid received in said well is released. By generating a negative pressure in one of the wells, a liquid can be sucked into the well, thereby removing it from the sample or a sample carrier the sample is received in. Other means of dispensing and removing liquid are possible, the aforementioned means are only mentioned as examples that are particularly easy to implement.

In another preferred embodiment, the trigger unit comprises a pressure head configured to be arranged atop the sample. The positioning unit is configured to individually position each of the wells of the pipetting element between the pressure head and the sample. Further, the pressure head is configured to generate an overpressure and/or a negative pressure in the well positioned between the pressure head and the sample. In this embodiment, the pressure head is the element of the trigger unit that triggers the release portions to release the pipetting liquids. The pipetting liquids are released when an overpressure is applied in the well. The pipetting liquids are removed from the sample when a negative pressure is applied in the well. The pressure head thus provides the pipetting device with means of dispensing and removed liquids, making the pipetting device very versatile.

In another preferred embodiment, the trigger unit comprises a trigger portion configured to mechanically trigger each of the release portions of the wells of the pipetting element individually in order to release the pipetting liquid. Mechanical solutions for releasing the pipetting liquids are simple and reusable, thereby making the pipetting device more cost effective and versatile.

In another preferred embodiment, the trigger unit comprises a puncturing element configured to puncture a or the membrane of each of the release portions of the wells of the pipetting element individually in order to release the pipetting liquid. In this embodiment, the membrane holds back the pipetting liquid until it is punctured by the puncturing element. The punctured membrane then allows the pipetting liquid to be dispensed from its well. This is particularly simple and cost-effective.

In another preferred embodiment, the trigger unit is configured to send an electric signal to the pipetting element for triggering each of the release portions of the wells of the pipetting element individually in order to release the pipetting liquid. As an alternative or in addition to a mechanical trigger portion, the trigger unit may also be configured to trigger the release portions electrically. This allows a very precise control over the release, because the release portion does not need to mechanically engage with the trigger portion in order to release the pipetting liquid. It further allows to trigger many release portions concurrently or consecutively in any order, making the pipetting device very flexible.

In another preferred embodiment, the pipetting device comprises at least one sample carrier having at least one sample receiving compartment configured to receive a sample. The sample position is configured to receive the sample carrier. The positioning unit is configured to selectively position each of the wells of the pipetting element next to and/or above the at least one sample receiving compartment. The sample receiving compartment may be any part or element of the sample carrier configured to receive at least one of the samples. For example, when the sample carrier is formed as a microwell plate, the sample receiving compartment may a well of the microwell plate. In this embodiment, the positioning unit is configured to selectively position each of the wells of the pipetting element such that the pipetting liquid contained therein may be dispensed in the sample receiving compartment. Thereby, every pipetting liquid received in the pipetting element may be dispensed into the sample receiving compartment. This allows the user to either select from a large number of pipetting liquids in a single experiment or to perform multiple cycles of staining and bleaching without refilling the pipetting element which increases the versatility and the walk away time of the pipetting device.

Preferably, the sample carrier may comprise two or more sample receiving compartments. When the sample carrier comprises more than one sample receiving compartment, the positioning unit may be configured to selectively position each of the wells of the pipetting element next to and/or above each of the sample receiving compartments. In this embodiment, the positioning unit is configured to selectively position each of the wells of the pipetting element such that the pipetting liquid contained therein may be dispensed in any of the sample receiving compartments. Thereby, every pipetting liquid received in the pipetting element may be dispensed into any of the sample receiving compartments.

In another preferred embodiment, the sample carrier comprises a or the trigger portion configured to mechanically trigger the each of the release portions of the wells of the pipetting element individually in order to release the pipetting liquid. In this embodiment, the trigger portion is part of the sample carrier itself and the trigger unit triggers the release portions by engaging the release portions of the pipetting element with the trigger portion of the sample carrier. Having the trigger portion as part of the sample carrier itself reduces the potential for a mismatch between the position of the release portion and the position of the sample receiving compartment. Therefore, this embodiment allows for a more precise release of the pipetting liquids.

Preferably, the sample carrier comprises a or the puncturing element configured to puncture a or the membrane of each of the release portions of the wells of the pipetting element individually in order to release the pipetting liquid. This embodiment of the trigger portion is particularly simple and cost-effective.

In another preferred embodiment, the pipetting device comprises a lid handling unit configured to remove the lid from the pipetting element and to arranged the lid on the pipetting element. This further increases the degree of automation of the pipetting device, thereby increases the ease of use and the walk away time of the pipetting device. An exemplary lid handling unit is described in the European Patent application EP 21186397.

In another preferred embodiment, the pipetting unit comprises a housing. The housing encloses at least the storage compartment. Preferably, the housing is formed such that the storage compartment is lighttight. The housing protects the storage compartment and the pipetting element received therein from the environment. This helps to prevent the pipetting liquids contained in the pipetting element from spoiling, thereby reducing waste and increasing the efficiency of the pipetting device. The housing may also comprise the sample position. Preferably, the housing comprises an external door providing access to the sample position and/or the storage compartment.

In another preferred embodiment, the pipetting device comprises at least one lighttight door arranged between the sample position and the storage compartment. The lighttight door shields the pipetting element from light when it is received in the storage compartment, thereby preventing reagents sensitive to light from spoiling, in particular when the external door of the housing is opened.

In another preferred embodiment, the pipetting device comprises a second pipetting unit configured to pipet the sample. Preferably, the second pipetting unit has a larger capacity for pipetting liquids than the first pipetting unit. The second pipetting unit may in particular be used to dispense at least one washing buffer into the sample. In this embodiment, the pipetting device forms a wholly integrated unit allowing staining, bleaching, and washing steps to be performed with a single device.

In another preferred embodiment, the pipetting device comprises a read out unit configured to read out an or the individual identifier of at least one well of the pipetting element. The individual identifiers allow the pipetting device to identify the wells and their content, further increasing the degree of automation of the pipetting device. The individual identifiers of the well, for example a bar code or a number, enable a user to determine the content of the well. The assignment between an individual identifier and the content of the well may be stored in a database.

Embodiments of the invention further relate to a pipetting kit comprising a pipetting element according to any one of the claims 1 to 12, wherein at least one of the wells is filled with a pipetting liquid suitable for carrying out a specific sample preparation.

The pipetting kit has the same advantages as the pipetting element described above and can be supplemented using the features of the dependent claims directed at the pipetting element.

In a preferred embodiment, the pipetting kit is configured as a one way consumable. In an alternative embodiment, at least some of the wells are configured to be refilled individually with pipetting liquid suitable to carry out a specific sample preparation.

In another embodiment, the pipetting kit comprises a plurality of wells, wherein each of the wells is filled with an individual pipetting liquid, and each of the wells comprises an individual identifier. At least a part of the plurality of wells is configured to be arranged at a predetermined position in a frame. The frame may comprise a plurality of identifiers matching the individual identifiers of the part of the plurality of wells, each identifier of the frame indicating the predetermined position of the matching well. The plurality of wells and the frame are configured to form a pipetting element as described above when the plurality of wells is arranged in the frame.

In another embodiment, the pipetting kit comprises a frame, wherein the frame comprises a plurality of identifiers matching individual identifiers of a plurality of wells, each identifier of the frame indicating the predetermined position of the matching well. The plurality of wells and the frame are configured to form a pipetting element as described above when the plurality of wells is arranged in the frame. In this embodiment, the pipetting kit only comprises the frame in which the wells of the pipetting element can be arranged.

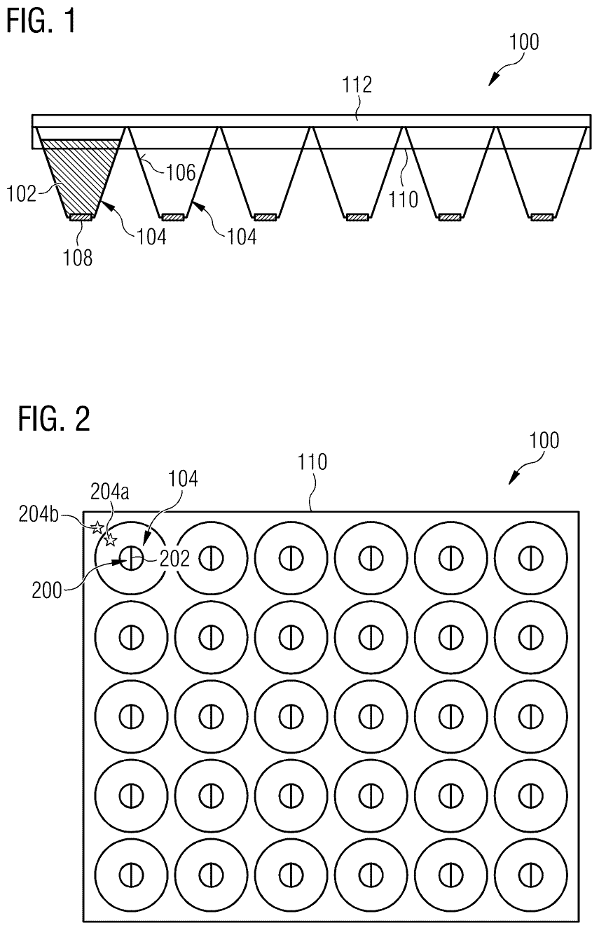

FIG. 1 is a schematic side view of a pipetting element 100 according to an embodiment.

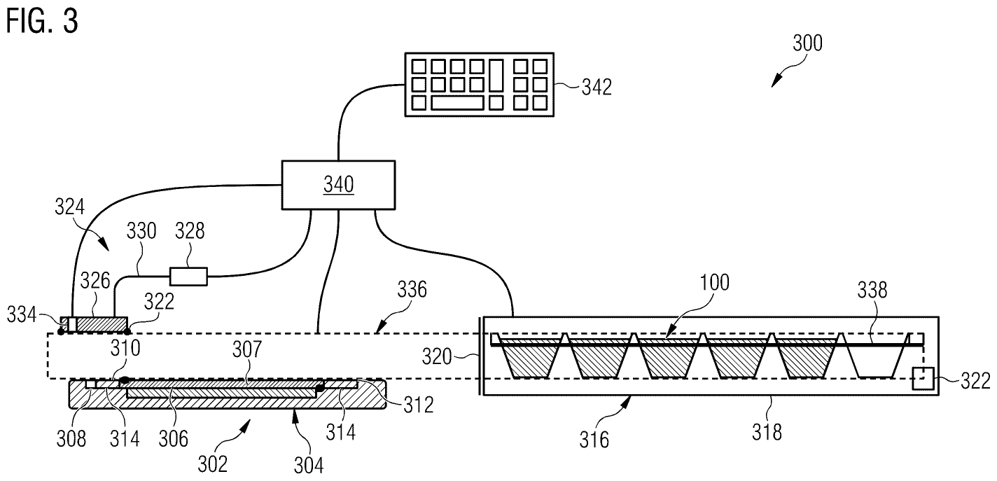

The pipetting element 100 is configured to store different pipetting liquids 102, and to release the pipetting liquids 102 into a sample or sample carrier 304 (c.f. FIG. 3). The pipetting liquids 102 may be reagents, such as probes, antibodies or chemicals. The pipetting liquids 102 may also comprise a combination of affinity reagents and fluorophores referred to as markers or staining solutions. Further, the pipetting liquids 102 may also be washing buffers configured to wash the aforementioned reagents, markers and staining solutions out of the sample.

The pipetting element 100 comprises distinct wells 104. Each well 104 is configured to receive one of the pipetting liquids 102. In FIG. 1, exemplary only the leftmost well 104 is filled with a pipetting liquid 102. The wells 104 have a capacity of at least 10 μL and at most 200 μL. An inner surface 106 the wells 104 may comprise a functional coating, for example to prevent the pipetting liquid 102 from sticking the inner surface 106. Each of the wells 104 comprises a release portion 108 exemplary arranged at the bottom of the well 104. The release portion 108 of each well 104 can be individually triggered in order to release the liquid contained in the well 104.

The pipetting element 100 further comprises a frame 110 in which the wells 104 are arranged. The frame 110 is configured to be received in a pipetting device 300 (c.f. FIG. 3). This allows the pipetting element 100 to be filled with the pipetting liquids 102 outside the pipetting device 300. The wells 104 may be detachable from the frame 110, allowing the wells 104 to be removed individually from the frame 110, for example for filling the removed well 104 with one of the pipetting liquids 102.

A lid 112 of the pipetting element 100 is configured to cover the wells 104. In the present embodiment, the lid 112 is exemplary formed as a plastic or glass lid covering all wells 104 at once. The lid 112 prevents the pipetting liquid 102 from drying out or coming into contact with pollutants in the environment. In other embodiments, the lid 112 may be configured to cover only some of the wells 104 or individual wells 104. In another embodiment, the wells 104 may comprise individual lids. The lid 112 may also be formed by foil, for example aloe, plastic or aluminum foil.

FIG. 2 is a schematic top view of the pipetting element 100 according to FIG. 1.

At the bottom of each well 104 a membrane 200 is arranged. The membrane 200 comprises a slit 202 that is closed as long as the pressure inside the well 104 is about equal to the pressure outside the well 104. As long as the slit 202 is closed, the pipetting liquid 102 contained in the well 104 is held back by the membrane 200. By applying an overpressure to the well 104, the slit 202 can be opened. When the slit 202 is open, the liquid contained in the well 104 is released.

As can be seen in FIG. 2, the frame 110 has a rectangular shape and the wells 104 are arranged in a grid like manner inside the frame 110. Each well 104 has a predetermined position inside the frame 110. In order to facilitate a correct assembly of the pipetting device 300, each well 104 comprises an individual identifier 204a that matches another identifier 204b arranged at the well's 104 predetermined position in the frame 110. The individual identifier 204a of each well 104 may also encode information about the pipetting liquid 102 contained in the well 104. The individual identifiers 204a, 204b may comprise any one of the following, a color, an alphanumeric string, a two-dimensional shape, and a three dimensional shape. In particular, the individual identifiers 204a, 204b may be machine readable such that a read out unit of the pipetting device 300 can identify the individual wells 104. For the sake of clarity, only one pair of individual identifiers 204a, 204b is shown.

FIG. 3 is a schematic view of the pipetting device 300 according to an embodiment.

The pipetting device 300 comprises a sample position 302 for the sample carrier 304. The sample carrier 304 has a sample receiving compartment 306 configured to receive the sample. In FIG. 3, the sample receiving compartment 306 is exemplary formed between a microscope slide arranged in the sample carrier 304 and a cover glass 307. The sample carrier 304 comprises an injection port 308 for introducing the pipetting liquid 102 into the sample receiving compartment 306. The injection port 308 comprises a lip portion 310 exemplary formed by an O-ring configured to engage with the release portion 108 of the pipetting element 100, and to form a seal when it is engaged with the release portion 108. This seal prevents pipetting liquid 102 from spilling when the pipetting liquid 102 is injected into the sample receiving compartment 306 via the injection port 308. The sample carrier 304 further comprises a venting port 312 through which a gas, for example air, can escape the sample receiving compartment 306 when the pipetting liquid 102 is introduced into the sample receiving compartment 306. The injection port 308 and the venting port 312 are connected to the sample receiving compartment 306 by a fluidics channel 314 each.

A storage compartment 316 of the pipetting device 300 is arranged to the right of the sample position 302 in FIG. 3. The storage compartment 316 is enclosed by a housing 318 and configured to receive the pipetting element 100. A door 320 is arranged on the left side of the storage compartment 316 in FIG. 3 providing access to the storage compartment 316. The door 320 may in particular be a sliding door. The storage compartment 316 further comprises a temperature and humidity control unit 322 configured to control the temperature and the humidity inside the enclosed storage compartment 316. Keeping the pipetting element 100 and the pipetting liquids 102 stored therein in a controlled environment prevents the pipetting liquids 102 from spoiling and allows long term experiments to be performed. In FIG. 3 the pipetting element 100 is arranged inside the storage compartment 316.

The pipetting device 300 also comprises a trigger unit 324 configured to trigger the release portions 108 of individual wells 104. The trigger unit 324 exemplary comprises a pressure head 326 that is connected to a pressure generating unit 328 by a pressure line 330. In the present embodiment, the trigger unit 324 is exemplary configured to generate an overpressure in the well 104 arranged below the pressure head 326. The overpressure causes the pipetting liquid 102 to be released. The trigger unit 324 is further configured to generate a negative pressure in the well 104 arranged below the pressure head 326, thereby sucking a liquid arranged in the sample receiving compartment 306 into the well 104. The pressure head 326 comprises a lip portion 332 exemplary formed by an O-ring that forms a seal with the top of the well 104 the pressure head 326 is engaged with. The read out unit 334 of the pipetting device 300 is exemplary positioned at the pressure head 326 and may be configured to determine if a well 104 is properly positioned underneath and/or to read out an identifier of a well 104.

A positioning unit 336 of the pipetting device 300 comprises a movable shelf 338 configured to receive the pipetting element 100. The positioning unit 336 is configured to move the shelf 338 and the pipetting element 100 received therein between the storage compartment 316 and the sample position 302. The positioning unit 336 is further configured to position each of the wells 104 of the pipetting element 100 between the pressure head 326 of the trigger unit 324 and the injection port 308 of the sample carrier 304. Thereby, the positioning unit 336 allows to select which of the wells 104 is engaged with the injection port 308, for example in order to inject a specific pipetting liquid 102 into the sample receiving compartment 306. The range of the positioning unit 336 is indicated by a dashed rectangle in FIG. 3.

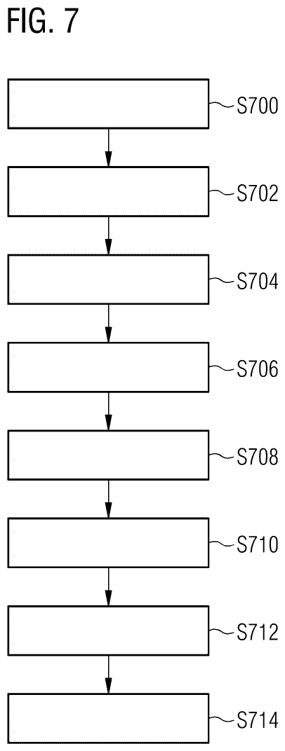

The pipetting device 300 further comprises a controller 340 connected to temperature and humidity control unit 322, the trigger unit 324, and the positioning unit 336 and configured to control the aforementioned elements. The controller 340 is further connected to a user input device 342 and configured to receive a user input from a user via the user input device 342. In particular, the controller 340 is configured to perform a method for preparing the sample received in the sample receiving compartment 306. The method is described below with reference to FIG. 7.

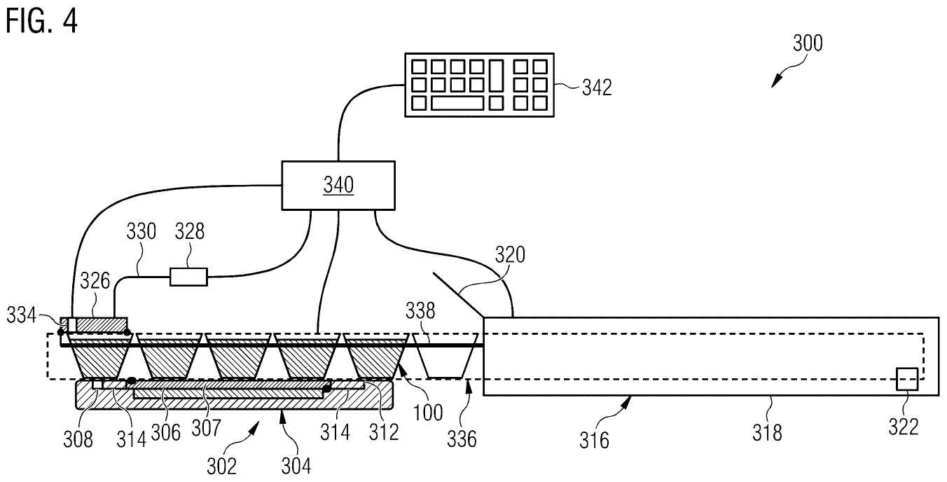

FIG. 4 is a schematic view of the pipetting device 300 according to FIG. 3.

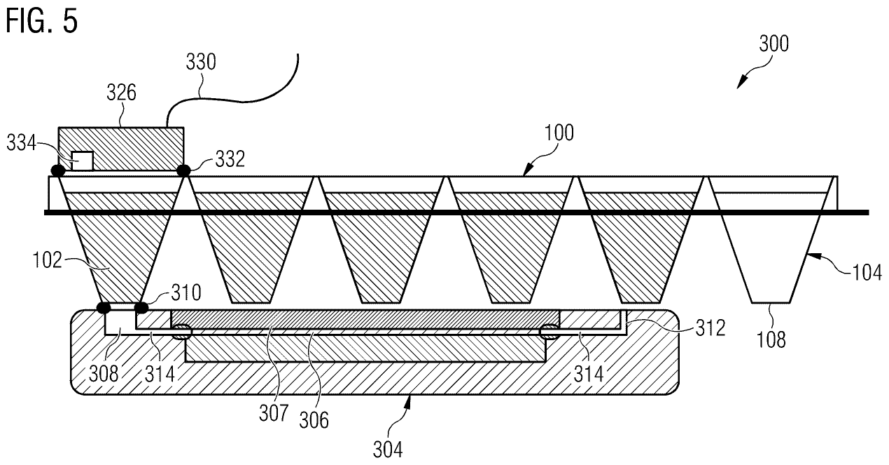

In FIG. 4 the pipetting element 100 is arranged at the sample position 302. The door 320 of the storage compartment 316 is opened allowing the positioning unit 336 to move the pipetting device 300 to the sample position 302 and back into the storage compartment 316. One of the wells 104 of the pipetting element 100 is arranged between the pressure head 326 of the trigger unit 324 and the injection port 308 of the sample carrier 304. This is described below in more detail with reference to FIG. 5 is a schematic detail view of the pipetting device 300 according to FIGS. 3 and 4.

In FIG. 5, the pressure head 326 is engaged with the top of one of the wells 104.

The lip portion 332 of the pressure head 326 forms a seal between the pressure head 326 and the well 104. The release portion 108 of the well 104 is engaged with the lip portion 310 of the sample carrier 304 forming a seal. Once an overpressure is generated in the well 104 by the pressure head 326, the slit 202 of that well 104 is opened and the pipetting liquid 102 contained in the well 104 is injected into the sample receiving compartment 306 via the injection port 308.

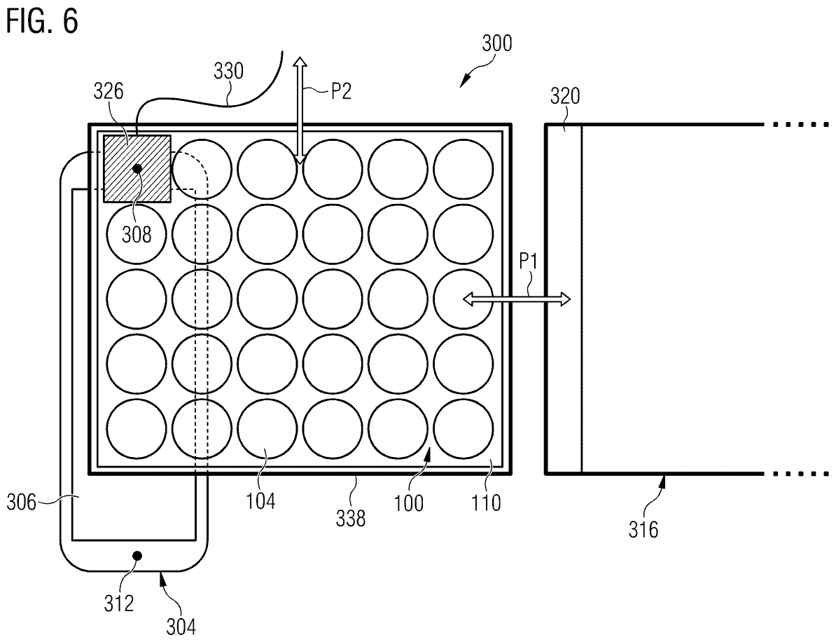

FIG. 6 is a schematic top view of the pipetting device 300 according to FIGS. 3 to 5.

The positioning unit 336 of the pipetting device 300 is configured to move the pipetting element 100 in two perpendicular directions as is indicated in FIG. 6 by two double headed arrows P1, P2. This allows the positioning unit 336 to arrange each of the wells 104 of the pipetting element 100 between the pressure head 326 of the trigger unit 324 and the injection port 308 of the sample carrier 304.

FIG. 7 is a flow chart of the method for preparing the sample that can be performed with the pipetting device 300 according to FIGS. 3 to 6.

In step S700 the process is started. In step S702 the user loads the pipetting element 100 with the pipetting liquids 102 by loading at least some of the wells 104 with one of the pipetting liquids 102. Preferably, this step is performed outside the pipetting device 300, for example on a work bench. Optionally, in this step the pipetting element 100 is covered with the lid 112. In step S704 the user gives the command to load the pipetting element 100 into the pipetting device 300 via the user input device 342. In reaction to that command, the controller 340 controls the positioning unit 336 to move the shelf 338 from the storage compartment 316 to the sample position 302 such that the user can load the pipetting element 100 into the shelf 338. Once the pipetting element 100 is positioned in the shelf 338, the user gives another command via the user input device 342 to retract the shelf 338 back into the storage compartment 316. In reaction to the second command, the controller 340 controls the positioning unit 336 to move the shelf 338 back into the storage compartment 316. In step S706 the user inputs the amount and type of the pipetting liquid 102 contained in each of the wells 104 into the controller 340 via the user input device 342. Alternatively, the information can be provided to the pipetting device 300 via a network or a wireless connection with a server.

In step S708 the user loads the sample carrier 304 comprising the sample into the pipetting device 300. In step S710 the user inputs a pipetting program into the controller 340 via the user input device 342. The pipetting program defines the amount, type, and the order in which the pipetting liquids 102 are to be injected into the sample carrier 304. The pipetting program may also specify that at certain times a liquid is to be sucked back into one of the wells 104. In step S712 the pipetting device 300 performs the pipetting program. In step S714 the process is ended.

Identical or similarly acting elements are designated with the same reference signs in all Figures. As used herein the term “and/or” includes any and all combinations of one or more of the associated listed items and may be abbreviated as “/”. Individual features of the embodiments and all combinations of individual features of the embodiments among each other as well 104 as in combination with individual features or feature groups of the preceding description and/or claims are considered disclosed.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Pipetting element
102 Pipetting liquid
104 Well
106 Inner surface
108 Release portion
110 Frame
112 Lid
200 Membrane
202 Slit
204a, 204b Identifier
300 Pipetting device
302 Sample position
304 Sample carrier
306 Sample receiving compartment
307 Cover glass
308 Injection port
310 Lip portion
312 Venting port
314 Fluidics channel
316 Storage compartment
318 Housing
320 Door
322 Control unit
324 Trigger unit
326 Pressure head
328 Pressure generating unit
330 Pressure line
332 Lip portion
334 Read out unit
336 Positioning unit
338 Shelf
340 Controller
342 Input device
P1, P2 Arrow

1. A pipetting element for use with a pipetting device, the pipetting element comprising:
at least two wells arranged in or forming a frame the frame being configured to be received by the pipetting device,
wherein each respective well of the at least two wells is configured to receive a pipetting liquid and has a release portion arranged at one side of the respective well, the release portion being configured to be triggered by the pipetting device in order to release the pipetting liquid.

2. The pipetting element according to claim 1, wherein the release portion is configured to be triggered mechanically by a trigger portion of the pipetting device or a sample carrier in order to release the pipetting liquid.

3. The pipetting element according to claim 1, wherein the release portion comprises a membrane configured to be punctured by a puncturing element of the pipetting device or a sample carrier in order to release the pipetting liquid.

4. The pipetting element according to claim 3, wherein the release portion comprises a slit or the membrane having the slit configured to release the pipetting liquid when an overpressure is applied to the respective well.

5. The pipetting element according to claim 1, wherein the release portion is configured to be triggered by an electrical signal received from the pipetting device in order to release the pipetting liquid.

6. The pipetting element according to claim 1, wherein an inner surface of at least one of the at least two wells comprises a functional coating.

7. The pipetting element according to claim 1, further comprising a lid configured to be received on the frame and to cover some or all of the at least two wells when the lid is received on the frame.

8. The pipetting element according to claim 1, wherein at least one of the at least two wells is configured to be lighttight.

9. The pipetting element according to claim 1, wherein the frame is rectangular, and the at least two wells are arranged inside the frame in a grid-like manner.

10. The pipetting element according to claim 1, wherein each respective well has a capacity of at least 10 μl and at most 200 μl.

11. The pipetting element according to claim 1, wherein each respective well comprises an individual identifier.

12. A pipetting device for pipetting a sample, the pipetting device comprising:
at least one pipetting element according to claim 1, and a pipetting unit;
wherein the pipetting unit comprises a sample position configured to receive the sample;
a storage compartment configured to receive the pipetting element;
a positioning unit configured to move the pipetting element between at least the storage compartment and the sample position; and
a trigger unit configured to trigger the pipetting element to release the pipetting liquid.

13. The pipetting device according to claim 12, wherein the storage compartment comprises a temperature control unit configured to control a temperature of the storage compartment.

14. The pipetting device according to claim 12, wherein the storage compartment comprises a humidity control unit configured to control a humidity of the storage compartment.

15. The pipetting device according to claim 12, wherein the positioning unit comprises a movable shelf configured to receive the pipetting element; and wherein the positioning unit is configured to move the movable shelf between the storage compartment and the sample position.

16. The pipetting device according to claim 12, wherein the trigger unit is configured to generate at least one of a capillary force, a gravity flow, an overpressure, or a negative pressure in each of the at least two wells of the pipetting element individually.

17. The pipetting device according to claim 16, wherein the trigger unit comprises a pressure head configured to be arranged atop the sample, wherein the positioning unit is configured to individually position each of the at least two wells of the pipetting element between the pressure head and the sample, and wherein the pressure head is configured to generate an overpressure and/or a negative pressure in the respective well positioned between the pressure head and the sample.

18. The pipetting device according to claim 12, wherein the trigger unit comprises a trigger portion configured to mechanically trigger the release portion of the respective well of the pipetting element in order to release the pipetting liquid.

19. The pipetting device according to claim 12, wherein the trigger unit comprises a puncturing element configured to puncture a membrane of the release portion of the respective well of the pipetting element in order to release the pipetting liquid.

20. The pipetting device according to claim 12, wherein the trigger unit is configured to send an electric signal to the pipetting element for triggering the release portion of the respective well of the pipetting element in order to release the pipetting liquid.

21. The pipetting device according to claim 12, further comprising at least one sample carrier having at least one sample receiving compartment configured to receive the sample, wherein the sample position is configured to receive the sample carrier, and wherein the positioning unit is configured to selectively position each of the at least two wells of the pipetting element next to and/or above the at least one sample receiving compartment.

22. The pipetting device according to claim 21, wherein the sample carrier comprises a trigger portion configured to mechanically trigger the release portion of the respective well of the pipetting element in order to release the pipetting liquid.

23. The pipetting device according to claim 21, wherein the sample carrier comprises a puncturing element configured to puncture a membrane of the release portion of the respective well of the pipetting element in order to release the pipetting liquid.

24. The pipetting device according to claim 12, wherein the pipetting unit comprises a housing, the housing enclosing at least the storage compartment.

25. The pipetting device according to claim 24 wherein the housing is formed such that the storage compartment is lighttight.

26. The pipetting device according to claim 12, further comprising at least one lighttight door arranged between the sample position and the storage compartment.

27. The pipetting device according to claim 12, further comprising a second pipetting unit configured to pipet the sample.

28. The pipetting device according to claim 12, further comprising a read out unit configured to read out an individual identifier of at least one well of the at least two wells of the pipetting element.

29. A pipetting kit comprising a pipetting element according to claim 1, wherein at least one of the at least two wells is filled with the pipetting liquid suitable for carrying out a specific sample preparation.

30. The pipetting kit of claim 29 being configured as a one way consumable.

31. The pipetting kit of claim 29, wherein at least some of the at least two wells are configured to be refilled individually with the pipetting liquid suitable to carry out the specific sample preparation.

32. A pipetting kit comprising a plurality of wells, wherein each of the plurality of wells is filled with an individual pipetting liquid, and each of the plurality of wells comprises an individual identifier, wherein at least a part of the plurality of wells is configured to be arranged at a predetermined position in a frame; wherein the frame comprises a plurality of identifiers matching the individual identifiers of the part of the plurality of wells, each identifier of the frame indicating a predetermined position of a matching well, and wherein the plurality of wells and the frame are configured to form a pipetting element according to claim 1 when the plurality of wells is arranged in the frame.

33. A pipetting kit comprising a frame, wherein the frame comprises a plurality of identifiers matching individual identifiers of a plurality of wells, each identifier of the frame indicating a predetermined position of a matching well, and wherein the plurality of wells and the frame are configured to form a pipetting element according to claim 1 when the plurality of wells is arranged in the frame.
